(19) United States
(12) Patent Application Publication
(10) Pub. No.: US 2016/0063508 A1
(43) Pub. Date: Mar. 3, 2016

(54) COMMUNICATION SYSTEM, IMAGE PROCESSING APPARATUS, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: Kenta Fukushima, Tokyo (JP)

(21) Appl. No.: 14/832,401

(22) Filed: Aug. 21, 2015

(30) Foreign Application Priority Data
Aug. 29, 2014 (JP) 2014-176220

(51) Int. Cl. G06Q 30/00; H04L 12/24; H04N 5/232

(52) U.S. Cl. CPC G06Q 30/016; H04N 5/23225; H04N 5/23206; H04L 41/5061; H04L 41/509; H04L 41/5051

(57) ABSTRACT

A communication system includes an image processing apparatus, an information processing apparatus configured to perform remote support on the image processing apparatus, and a management server configured to manage information relating to the image processing apparatus. Upon accepting a remote support service start request issued from the image processing apparatus, if the information managed by the management server is not the latest information, the image processing apparatus issues a request regarding the latest information and start of the remote support service to the management server. On the other hand, if the information managed by the management server is the latest information, the image processing apparatus issues a request regarding start the remote support service without updating the information.

### BACKGROUND OF THE INVENTION

1. Field of the Invention

The present invention relates to a communication system, an image processing apparatus, a method for controlling an image processing apparatus, and a storage medium.

2. Description of the Related Art

When a procedure for handling trouble with a product is complicated, a customer often directly calls a call center of a manufacturer to ask questions and obtain answers. In view of this, in Japanese Patent Laid-Open No. 2005-208974, in order to immediately perform troubleshooting between an image processing apparatus and a call center, a remote maintenance service using audio or video communication or remote operations is considered. With the remote maintenance service, the image processing apparatus receiving support and an information processing apparatus of the call center performing support are usually in a firewall. Thus, Japanese Patent Laid-Open No. 2013-029922 proposes that in the case where communication is performed between the image processing apparatus and the information processing apparatus, a relay server that relays communication between both apparatuses is installed on the Internet. By installing such a relay server, communication between apparatuses in the firewall is possible.

Also, in order to immediately perform troubleshooting, it is necessary to know the status of the image processing apparatus in the call center. Thus, although each image processing apparatus stores log and counter information, there is an upper limit on the amount of information to be stored in the image processing apparatus, and thus Japanese Patent Laid-Open No. 2009-048263 proposes a system for periodically transmitting log or counter information to a device information management server. In the call center, the status of the image processing apparatus can be found out by accessing such a device information management server, and thereby trouble can be resolved immediately.

However, the above-described conventional technique has the following issues. For example, in the case where the above-described conventional technique is applied as the device information management server in the remote maintenance service, there is a possibility that when the remote maintenance service is started, information transmitted to the device information management server is not the latest information. The device information management server collects the device information of many image processing apparatuses. Therefore, taking the load on the device information management server into consideration, each image processing apparatus transmits information according to a predetermined schedule. For example, if an image processing apparatus that is scheduled to transmit device information 0:00 at night starts a remote maintenance service at 13:00 in the daytime, the image processing apparatus performs a remote maintenance service without transmitting the device information during a period of 13 hours.

### SUMMARY OF THE INVENTION

The present invention enables realization of controlling a remote maintenance service based on the information on the latest status of each image processing apparatus when performing the service.

One aspect of the present invention provide a communication system including an image processing apparatus, an information processing apparatus configured to perform remote support on the image processing apparatus, and a management server configured to manage information relating to the image processing apparatus; the image processing apparatus comprises: an acceptance unit configured to accept a remote support service start request issued from the information processing apparatus; a determination unit configured to determine whether or not the information that is managed by the management server and relates to the image processing apparatus is latest information; and a request unit configured to, in a case where the determination unit determines that the information that is managed by the management server and relates to the image processing apparatus is not the latest information, issue a request regarding the latest information and start of the remote support service to the management server, and, in a case where the determination unit determines that the information that is managed by the management server and relates to the image processing apparatus is the latest information, issue a request regarding start of the remote support service to the management server; and an acquisition unit configured to acquire information relating to the remote support service from the information processing apparatus, and the management server comprises: a management unit configured to manage information of a plurality of apparatuses included in the communication system; and a notification unit configured to, upon accepting the remote support service start request from the image processing apparatus, notify the information processing apparatus providing the remote support service of the remote support service start request, and notify the information processing apparatus of the information that is managed by the management server and relates to the image processing apparatus in accordance with the request from the information processing apparatus.

Another aspect of the present invention provide an image processing apparatus configured to receive remote support from an information processing apparatus, the image processing apparatus comprising: an acceptance unit configured to accept a remote support service start request issued from the information processing apparatus; a determination unit configured to determine whether or not information that is managed by a management server to be connected via a network and relates to the image processing apparatus is latest information; a request unit configured to, in a case where the determination unit determines that the information that is managed by the management server and relates to the image processing apparatus is not the latest information, issue a request regarding the latest information and start of the remote support service to the management server, and, in a case where the determination unit determines that the information that is managed by the management server and relates to the image processing apparatus is the latest information, issue a request regarding start of the remote support service to the management server; and an acquisition unit configured to acquire information relating to the remote support service from the information processing apparatus having the latest information that is notified via the management server and relates to the image processing apparatus.

Still another aspect of the present invention provide a method for controlling an image processing apparatus configured to receive remote support from an information processing apparatus, the method comprising: accepting a remote support service start request issued from the information processing apparatus; determining whether or not information that is managed by a management server to be connected via a network and relates to the image processing apparatus is latest information; issuing a request regarding the latest information and start of the remote support service to the management server in a case where it is determined in the determining that the information that is managed by the management server and relates to the image processing apparatus is not the latest information, and, issuing a request regarding start of the remote support service to the management server in a case where it is determined in the determining that the information that is managed by the management server and relates to the image processing apparatus is the latest information; and acquiring information relating to the remote support service from the information processing apparatus having the latest information that is notified via the management server and relates to the image processing apparatus.

Yet still another aspect of the present invention provide a non-transitory computer-readable storage medium storing a computer program for causing a computer to execute each step in a method for controlling an image processing apparatus, the method comprising: accepting a remote support service start request issued from the information processing apparatus; determining, by a determination unit, whether or not information that is managed by a management server to be connected via a network and relates to the image processing apparatus is latest information; issuing a request regarding the latest information and start of the remote support service to the management server in a case where it is determined in the determining that the information that is managed by the management server and relates to the image processing apparatus is not the latest information, and, issuing a request regarding start of the remote support service to the management server in a case where it is determined in the determining that the information that is managed by the management server and relates to the image processing apparatus is the latest information; and acquiring information relating to the remote support service from the information processing apparatus having the latest information that is notified via the management server and relates to the image processing apparatus.

Further features of the present invention will be apparent from the following description of exemplary embodiments with reference to the attached drawings.

### BRIEF DESCRIPTION OF THE DRAWINGS

FIG. 1 is a diagram of an overall communication system according to a first embodiment.

FIG. 2 is a block diagram showing a configuration of a MFP 100 according to the first embodiment.

FIG. 3 is a block diagram showing the configuration of a PC 110, a relay server 120, and a management server 130 according to the first embodiment.

FIG. 4 is a diagram showing a sequence according to the first embodiment.

FIGS. 5A and 5B are flowcharts showing operations of the MFP 100 according to the first embodiment.

FIG. 6 is a flowchart showing operations of the PC 110 according to the first embodiment.

FIG. 7 is a flowchart showing operations of the relay server 120 according to the first embodiment.

FIG. 8 is a flowchart showing operations of the management server 130 according to the first embodiment.

FIG. 9 is a diagram showing a sequence according to a second embodiment.

FIGS. 10A and 10B are flowcharts showing operations of a MFP 100 according to the second embodiment.

FIG. 11 is a flowchart showing operations of the PC 110 according to a second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

System Configuration

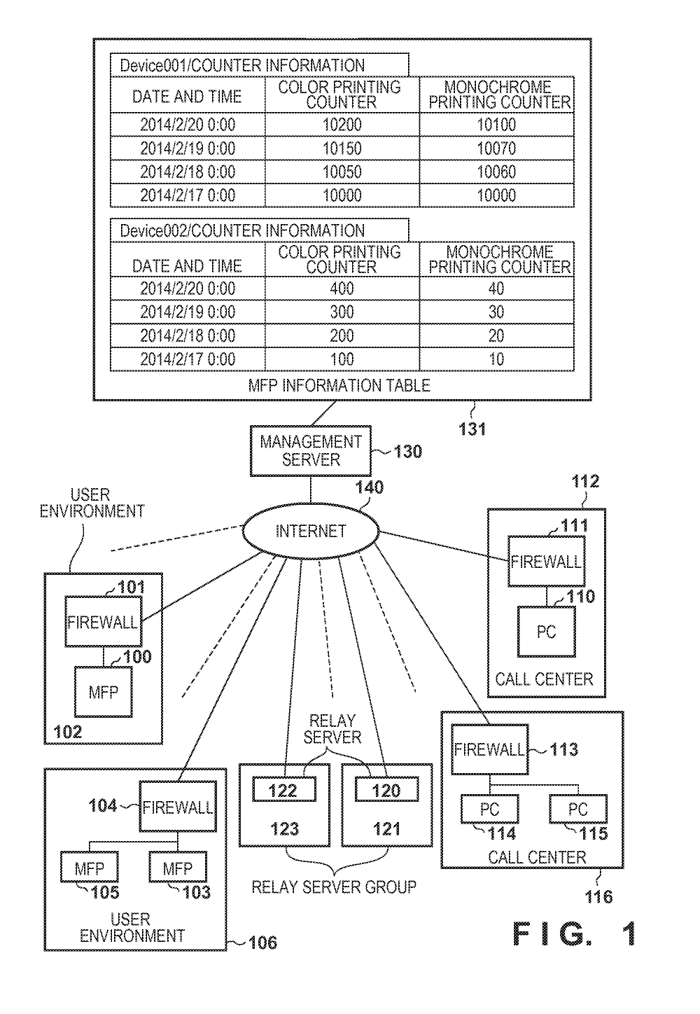

Hereinafter, a first embodiment of the present invention will be described with reference to FIGS. 1 to 8. First, the overall configuration of a communication system according to this embodiment will be described with reference to FIG. 1. This communication system realizes a remote maintenance service that provides resolutions or the like to the apparatus in the case where a product such as a MFP has trouble. A MFP (Multi Function Peripheral) 100, which is an image processing apparatus, is disposed in a user environment 102 and is operated by a user. A PC 110, which is an information processing apparatus, is disposed in a call center 112 and is operated by an operator. A plurality of the user environments 102 and the call centers 112 may be present, and as shown in FIG. 1, MFPs 105 and 106 and PCs 114 and 115 respectively included in more user environments 103 and call centers 116 may be further included in this system.

Firewalls 101 and 104 are respectively installed in the user environments 102 and 103 and firewalls 111 and 113 are respectively installed in the call centers 112 and 116. As shown in FIG. 1, the user environments 102 and 103 indicate the environment of a customer including a product such as a MFP. On the other hand, the call centers 112 and 116 indicate groups providing support to resolve trouble with the product. For example, in the case where the MFP 100 has trouble and a user cannot perform troubleshooting personally, the user can access the call center 112 and make an inquiry about a resolution. The firewalls 101 and 104 are configured to permit connection from a terminal in the user environments 102 and 103 to an Internet 140, and to reject connection from the Internet 140 to the terminal in the user environments 102 and 103. The firewalls 111 and 113 are configured to permit connection from terminals in the user environments 112 and 116 to the Internet 140, and to reject connection from the Internet 140 to the terminals in the user environments 112 and 116.

Relay server groups 121 and 123 are server groups constituted by server computers that provide relay services via the Internet 140, and each relay server may be constituted by one server computer, or may be constituted by a plurality of server computers. FIG. 1 shows the configuration in which the relay server groups 121 and 123 respectively include only one relay server 120 and 122. The MFP 100 and the PC 110 respectively include a data communication function through HTTP (Hyper Text Transfer Protocol). In data communication through HTTP, client nodes perform data communication by repeatedly performing POST and GET to a URL (Uniform Resource Locator) provided by a HTTP relay server. In the present embodiment, repeatedly performing POST is referred to as “POST polling” and repeatedly performing GET is referred to as “GET polling”. Accordingly, the client nodes can perform data communication even if the client nodes are blocked by a private address area or a firewall. In the present embodiment, the MFP 100 and the PC 110 operate as HTTP client nodes.

Also, a module monitoring the MFP is incorporated in the MFP 100. This module monitors the status of the MFP 100 and notifies the management server 130 of the status information of the MFP 100. The relay server 120 operates as the HTTP relay server. The management server 130 is installed on the Internet, and collects and manages the information of the MFP by communication with the monitoring module in the MFP installed in each user environment 102. The information of the MFP collected by the management server 130 (referred to as “management information”, hereinafter) includes at least one of operating information such as a counter value for a processing result or the like, an operating log, and a part counter value (part replacement information) indicating the consumed level of a plurality of parts used in the MFP, and failure information indicating hardware failure, jam information, and the like.

The management server 130 stores a MFP information table 131. The management server 130 can provide a basic usage status of a device to the call center 112 using the MFP information table 131. Specifically, upon logging in to the management server 130, an operator, who is a user of the management server 130, can check the status of the MFP 100 by displaying information collected from the MFP 100, which is a monitoring target, on a display unit, for example. The management server 130 manages the information of the MFP 100 and the call center 112 corresponding to the MFP 100. Also, although the MFP 100 and the PC 110 are configured to communicate with the Internet 140 via the firewalls 101 and 111 in the present embodiment, a network configuration in which the firewalls 101 and 111 are not used is possible. Also, a protocol other than HTTP may be applied as a communication protocol in the present embodiment.

Configuration of Image Processing Apparatus

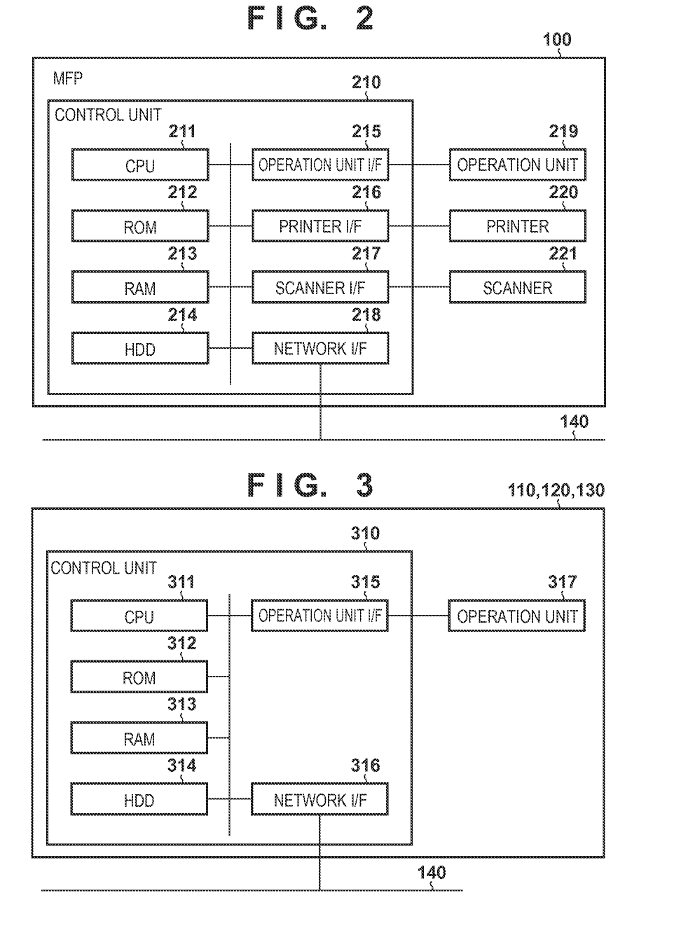

Next, the configuration of the MFP 100 will be described with reference to FIG. 2. A control unit 210 including a CPU 211 controls overall operations of the MFP 100. The CPU 211 realizes the function of the MFP 100, the processing of the MFP 100 according to a sequence diagram, which will be described later, and the processing of a flowchart relating to the MFP 100 by executing programs stored in a ROM 212 and a HDD 214. Here, it is assumed that one CPU 211 uses one memory (RAM 213 or HDD 214) to realize the function of the MFP 100, the processing of the MFP 100 in the later-described sequence diagram, and the processing of the flowchart relating to the MFP 100, but another configuration is possible. For example, a configuration is possible in which a plurality of CPUs use a plurality of RAMs or HDDs to realize the function of the MFP 100, the processing of the MFP 100 in the later-described sequence diagram, and the processing of the flowchart relating to the MFP 100.

The ROM 212 stores various types of programs executed by the CPU 211. The RAM 213 is used as a temporary storage area of the CPU 211, such as a main memory or work area. The HDD 214 stores image data and various types of programs. An operation unit I/F 215 connects an operation unit 219 and a control unit 210. The operation unit 219 includes a liquid crystal display unit having a touch panel function, a keyboard, and the like.

A printer I/F 216 connects a printer 220 and the control unit 210. The control unit 210 transmits image data to be printed to the printer 220 via the printer I/F 216. The printer 220 prints the image data accepted from the control unit 210 on a recording medium via the printer I/F 216.

A scanner I/F 217 connects a scanner 221 and the control unit 210. The scanner 221 reads an image on a document and generates image data (image file), and then inputs the generated image data to the control unit 210 via the scanner I/F 217. The MFP 100 can transmit the image data (image file) generated by the scanner 221 as a file or an e-mail. A network I/F 218 connects the control unit 210 and the Internet 140.

Configuration of Information Processing Apparatus

Next, the configurations of the PC 110, the relay server 120, and the management server 130, which are information processing apparatuses, will be described with reference to FIG. 3. A control unit 310 including a CPU 311 controls overall operations of the PC 110. The CPU 311 realizes the function of the PC 110, the processing of the PC 110 in the later-described sequence diagram, and the processing of the flowchart relating to the PC 110 by executing programs stored in a ROM 312 or a HDD 314. The ROM 312 stores various types of programs executed by the CPU 311. A RAM 313 is used as a temporary storage area of the CPU 311, such as a main memory or work area. The HDD 314 stores image data and various types of programs.

An operation unit I/F 315 connects an operation unit 317 and the control unit 310. The operation unit 317 includes a liquid crystal display unit having a touch panel function, a keyboard, a mouse, and the like. A network I/F 316 connects the control unit 310 and the Internet 140.

It is assumed that the hardware configuration of the relay server 120 is similar to the hardware configuration of the PC 110. Specifically, the CPU 311 of the relay server 120 executes a program stored in the ROM 312 or the HDD 314 of the relay server 120. Accordingly, the relay server 120 realizes the function of the relay server 120, the processing of the relay server 120 in a sequence diagram, which will be described later, and the processing of a flowchart relating to the relay server 120.

Sequence

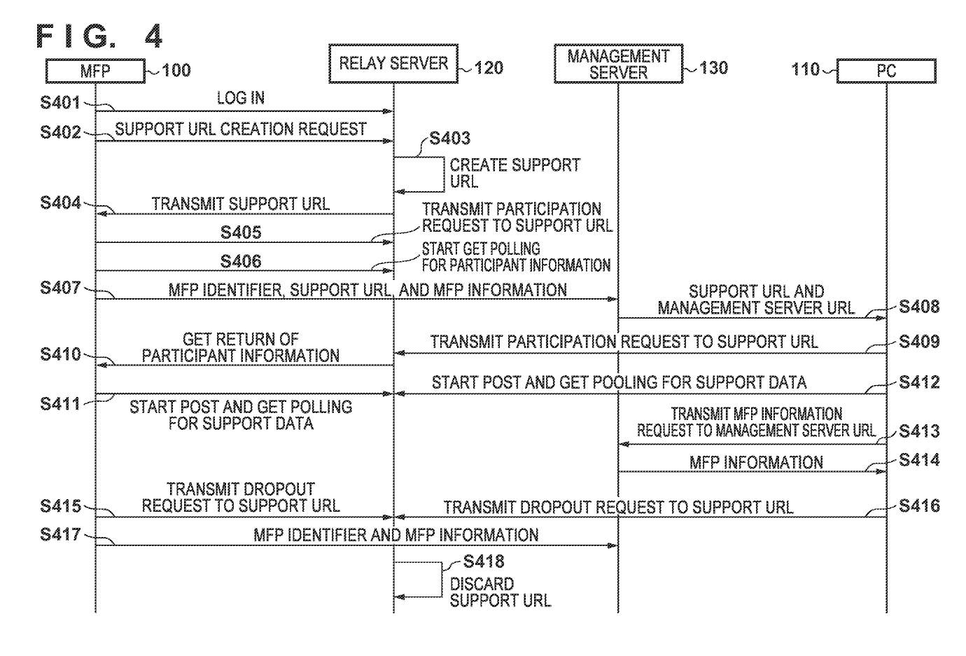

Next, sequence processing of the MFP 100, the PC 110, the relay server 120, and the management server 130 will be described with reference to FIG. 4. Operations of this sequence diagram are realized by the CPU 211 of the MFP 100 executing a control program stored in the HDD 214. Also, the operations are realized by the CPUs 311 of the PC 110, the relay server 120, and the management server 130 executing control programs stored in the HDDs 314.

First, when a user operates the operation unit 219 of the MFP 100 to start support in step S401, the MFP 100 performs connection processing on the relay server 120. Here, “support” is a remote maintenance service provided by the system according to the present embodiment, and indicates a service according to which trouble with the MFP 100 is resolved immediately by a customer (user) accessing the call center 112, 116, or the like to make an inquiry about a resolution, for example. In other words, it is assumed that the MFP 100 has some kind of trouble in step S401. The user starts a procedure for support to resolve the trouble. More specifically, the relay server 120 performs authentication by the user inputting authentication information via the operation unit 219, and if authentication is successful, connection is complete. When connection processing is complete, the procedure advances to step S402, and the MFP 100 requests a support URL from the relay server 120. The relay server 120 assigns the support URL in accordance with the request from the MFP 100 in step S403, and transmits the assigned support URL to the MFP 100 in step S404.

In step S405, the MFP 100 transmits a participation request to the support URL. Upon receiving the request to participate in the support URL, the relay server 120 buffers the information of the MFP 100 in the RAM 313 as a participant. Subsequently, in step S406, the MFP 100 periodically transmits a GET request for supporter information to the relay server 120. Upon receiving the GET request for participant information transmitted to the support URL, the relay server 120 transmits update information of the participant that was buffered in the RAM 313 to the requestor as a reply. Also, upon receiving a dropout request transmitted to the support URL, the relay server 120 deletes information from the participant information buffered in the RAM 313.

In step S407, the MFP 100 transmits the support URL assigned by the relay server 120, its identification information, and the latest MFP information to the management server 130. The MFP identification information is unique identification information to specify the MFP 100. Although it will be described later, the management server 130 manages counter information of the MFP as the MFP information. The counter information of the MFP 100 can be acquired by connecting to a management server URL. When giving support to the MFP 100, the operator can reference the status of a past counter. Although counter information is handled as an example of the MFP information in the present embodiment, other information such as part replacement information or error history may be handled. It is assumed that usually the MFP 100 is configured to periodically transmit the MFP information to the management server 130 on a predetermined schedule (at a predetermined time interval) taking the load on the management server 130 into consideration. However, in step S407, this schedule is changed and the MFP information is immediately transmitted.

In step S408, the management server 130 specifies the call center 112 that maintains and manages the MFP 100 based on the MFP information table 131 and transmits the support URL and the management server URL to the corresponding PC 110 by an e-mail. By using the e-mail, the management server 130 can notify the PC 110 of information required for support even in an environment where the firewall 111 is present. Not that although a description is given below assuming that notification is issued using an e-mail, another protocol may be used. For example, a method of acquiring data from the management server 130 by the PC 110 polling the management server 130 may be used in order to pass through the firewall 111. The management server URL is a URL for accessing the management server, and information managed by the management server 130 can be acquired by accessing the URL from outside.

Upon receiving the support URL from the management server 130, the PC 110 transmits a participation request to the support URL in step S409. The relay server 120 buffers the information of the PC 110 in the RAM 213 as a participant. Also, in step S410, the relay server 120 transmits the participant information to the MFP 100 as a response to the GET request (step S406) for the participant information received from the MFP 100. Accordingly, the MFP 100 can know that the PC 110 was selected as an apparatus that gives support to the MFP 100.

Thereafter, in steps S411 and S412, the MFP 100 and the PC 110 periodically transmit a POST request and a GET request to the assigned support URL to communicate support data via the relay server 120. For example, it is assumed that in the case where a failure such as a jam error occurs in the MFP 100 and the user cannot perform failure restoration, in order to find the cause, the user notifies the operator in the call center 112 of the failure information using the MFP 100. In this case, when the MFP 100 posts information indicating the failure on the support URL, the relay server 120 stores the information in the RAM 313. Thereafter, when the PC 110 of the call center 112 transmits the GET request to the support URL, the relay server 120 transmits the information stored in the RAM 313 to the PC 110 as a response. It is assumed that the operator in the call center 112 who knows the cause of the failure based on the information transmitted from the MFP 100 subsequently uses a video to inform the user of the MFP 100 about a method for cancelling the error. In this case, when the operator in the call center 112 transmits the POST request of the video data to the support URL by operating the PC 110, the relay server 120 stores the video data in the RAM 313. Thereafter, when the MFP 100 transmits the GET request to the support URL, the video data stored in the RAM 313 of the relay server 120 is transmitted to the MFP 100.

Note that as described above, the management server 130 manages various types of information such as error history of the MFP 100. The PC 110 connects to the management server URL transmitted from the management server 130 in step S408 in step S413, and then the PC 110 acquires the information of the MFP 100 in step S414. Accordingly, the operator can reference the past error occurrence status or the like when giving the support to the MFP 100.

When the support given by the operator ends, the MFP 100 and the PC 110 transmit a dropout request to the support URL in steps S415 and S416. In step S417, the MFP 100 is synchronized with the dropout request and transmits the MFP identifier and the MFP information to the management server 130. In step S418, the relay server 120 cancels unnecessary assignment of the support URL.

Processing Procedure of MFP

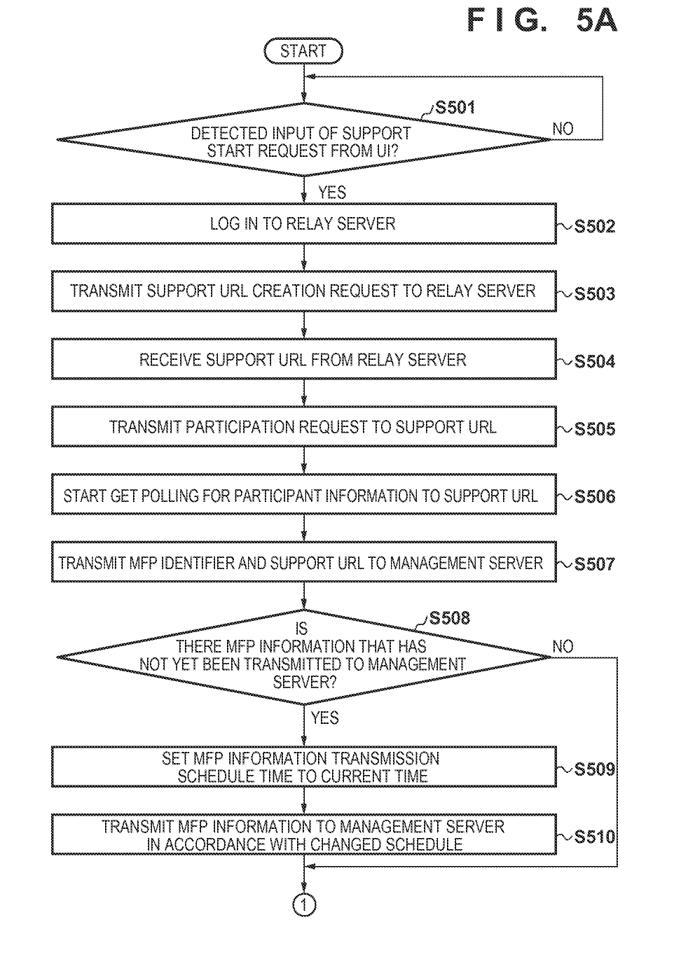

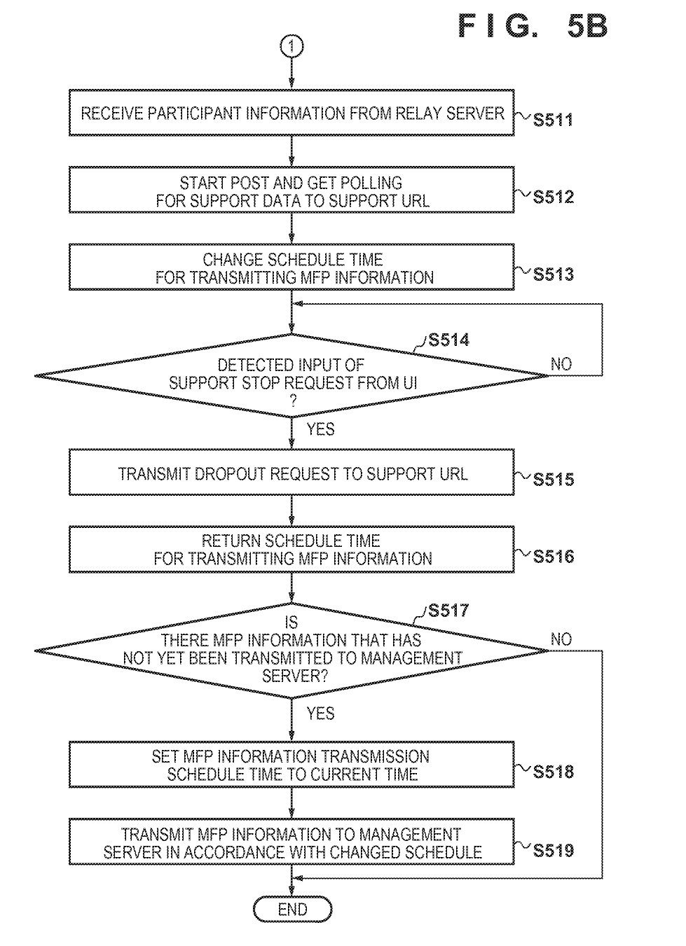

Next, the processing procedure of the MFP 100 will be described with reference to FIGS. 5A and 5B. Operations (steps, S) shown in the flowchart of FIGS. 5A and 5B are realized by the CPU 211 of the MFP 100 executing a control program stored in the HDD 214.

The CPU 211 determines in step S501 whether or not the CPU 211 has accepted the input of a support start request from the operation unit 219. When the input has been accepted, the processing advances to step S502, and the CPU 211 performs an operation to log in to the relay server 120 in accordance with the accepted input information. In step S503, the CPU 211 transmits a support URL creation request to the relay server 120. In step S504, the CPU 211 receives the support URL from the relay server 120. In step S505, the CPU 211 transmits a participation request to the received support URL. Subsequently, in step S506, the CPU 211 starts GET polling for participant information to the support URL. Furthermore, in step S507, the CPU 211 transmits the MFP identifier and the support URL to the management server 130.

Next, the CPU 211 determines in step S508 whether or not there is MFP information (status information) that was transmitted previously but has not yet been transmitted to the management server 130. This is performed by, in the case where the MFP information is counter information, determining whether or not the counter information has been updated after counter information was most recently transmitted to the management server 130 and before the current time, for example. In other words, it is determined whether or not the information managed by the management server 130 is old. If there is MFP information that has not yet been transmitted to the management server 130, the processing advances to step S509, and if not, the processing advances to step S511.

In step S509, the CPU 211 sets the next schedule time at which the MFP information is to be transmitted to the management server 130 to the current time. Subsequently, the CPU 211 immediately transmits the MFP information and the MFP identifier to the management server 130 in accordance with the schedule set in step S509 in step S510, and the processing advances to step S511. On the other hand, in the case where it is determined in step S508 that there is no MFP information that has not yet been transmitted, the CPU 211 advances to the processing of step S511 without executing the processing of steps S509 and S510.

In step S511, the CPU 211 receives participant information from the relay server 120. Subsequently, in step S512, the CPU 211 starts POST polling and GET polling for support data to the support URL. Examples of the support data include a video, audio, and command data for remote operation. Accordingly, the user of the MFP 100 can receive support from the operator through audio or video communication, or a remote operation.

When support is started, the CPU 211 changes the schedule for transmitting the MFP information in step S513. This is because there is a high possibility that the status of the MFP will change during the support. Specifically, transmission frequency is increased such that transmission is performed every five minutes. In other words, when a remote support service is started, the CPU 211 changes the schedule such that the MFP information is transmitted to the management server 130 at a shorter time interval than before the remote support service is started.

The CPU 211 determines in step S514 whether or not the CPU 211 has accepted the input of a support stop request from the operation unit 219. When the input of the support stop request is detected, the processing advances to step S515. In step S515, the CPU 211 transmits a dropout request to the support URL. Upon transmitting the dropout request, in step S516, the CPU 211 returns the transmission schedule changed in step S513 to the original usual state. In other words, the CPU 211 changes the shortened interval at which the MFP information is transmitted to the transmission interval used in ordinary circumstances. Thereafter, similarly to the processing of step S508 to step S510, the CPU 211 transmits the MFP identifier and the MFP information to the management server 130 in step S517 to step S519. This is because there is a high possibility that the status of the MFP will change when the support ends. Also, the MFP information transmitted at this time may include a call record made while undergoing the support or a record of the support.

Processing Procedure of PC

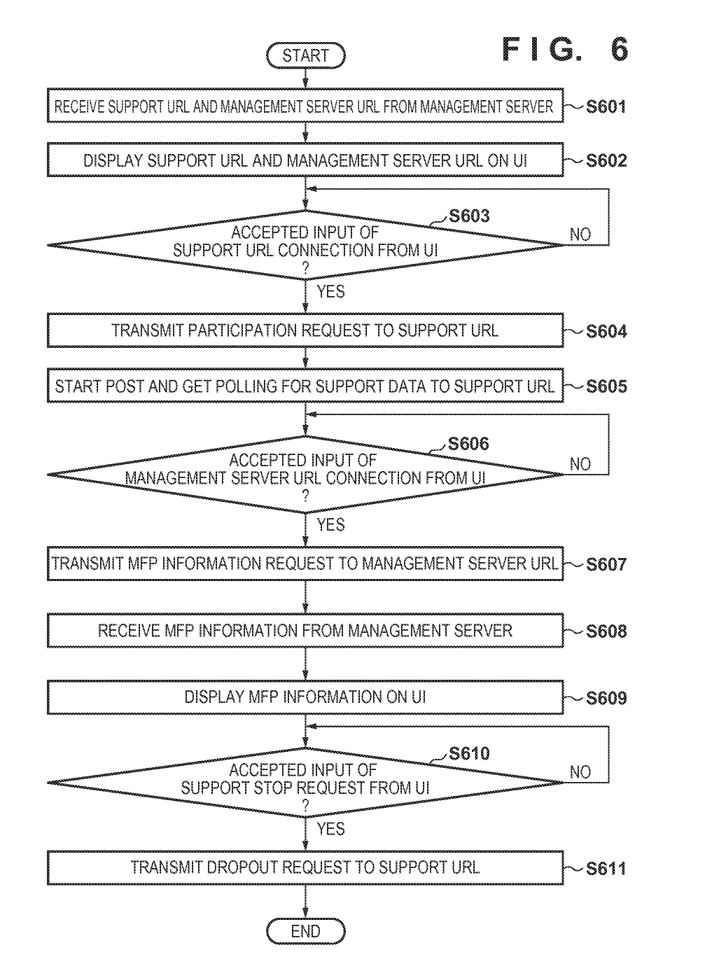

Next, the processing procedure of the PC 110 will be described with reference to FIG. 6. Operations (steps, S) shown in the flowchart of FIG. 6 are realized by the CPU 311 of the PC 110 executing a control program stored in the HDD 314.

In step S601, the CPU 311 receives a support URL and a management server URL from the management server 130. Subsequently, in step S602, the CPU 311 displays the support URL and the management server URL on the operation unit 317. Here, the information of the received e-mail may be displayed on the operation unit 317 as is, or may be displayed as an application screen.

The CPU 311 determines in step S603 whether or not the CPU 311 has accepted the input of a support URL connection from the operation unit 317. In the case where it is determined that the CPU 311 has accepted the input, the processing advances to step S604. In step S604, the CPU 311 transmits a participation request to the accepted support URL. In step S605, the CPU 311 starts POST polling and GET polling for the support data to the support URL. Accordingly, the operator can give support to the user of the MFP 100 through audio or video communication, or a remote operation.

The CPU 311 determines in step S606 whether or not the CPU 311 has accepted the input of connection to the management server URL from the operation unit 317. If it is determined that the CPU 311 has accepted the input, the processing advances to step S607. In step S607, the CPU 311 transmits the MFP information request to the management server URL. In step S608, the CPU 311 receives the MFP information from the management server 130. In step S609, the CPU 311 displays the received MFP information on the operation unit 317. Accordingly, when giving support, the operator can reference the past error occurrence status of the MFP 100, for example.

The CPU 311 determines in step S610 whether or not the CPU 311 has accepted the support stop request from the operation unit 317. If it is determined that the CPU 311 has accepted the support stop request, the processing advances to step S611. In step S611, the CPU 311 transmits the dropout request to the support URL and ends the processing.

Processing Procedure of Relay Server

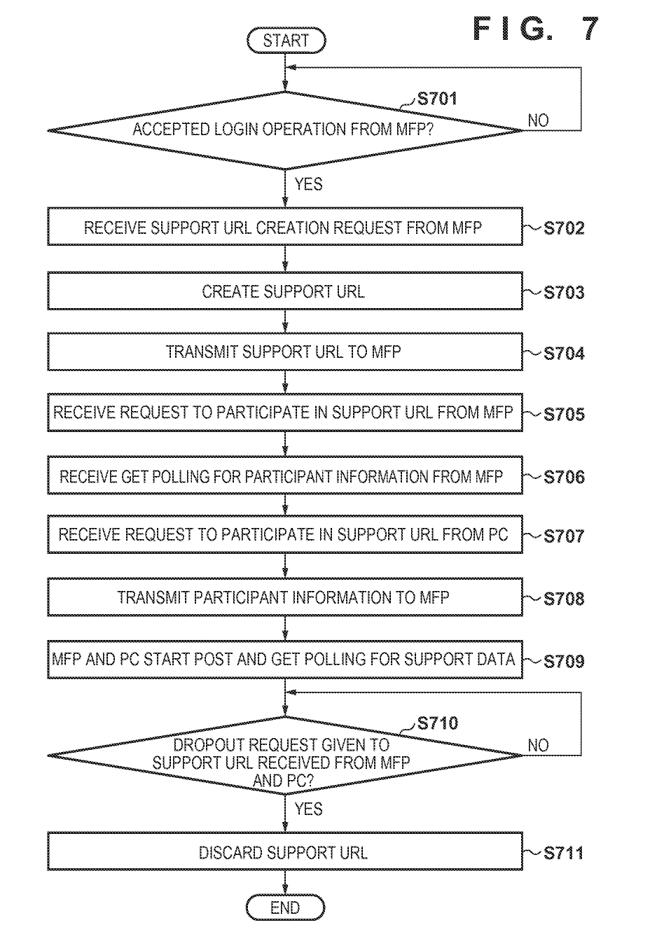

Next, the processing procedure of the relay server 120 will be described with reference to FIG. 7. Operations (steps, S) shown in the flowchart of FIG. 7 are realized by the CPU 311 of the relay server 120 executing a control program stored in the HDD 314.

The CPU 311 determines in step S701 whether or not the CPU 311 has accepted a login operation from the MFP 100. If it is determined that the CPU 311 has accepted the login operation, the processing advances to step S702. In step S702, the CPU 311 receives a request for creating the support URL from the MFP 100. Subsequently, the CPU 311 creates the support URL in step S703. In step S704, the CPU 311 transmits the created support URL to the MFP 100.

Next, in step S705, the CPU 311 receives a request to participate in the support URL from the MFP 100. Subsequently, in step S706, the CPU 311 receives GET polling of the participant information from the MFP 100. In step S707, the CPU 311 receives the request to participate in the support URL from the PC 110. In step S708, the CPU 311 transmits the participant information to the MFP 100. In step S709, the CPU 311 receives POST polling and GET polling of the support data from the MFP 100 and the PC 110. Accordingly, the support data is exchanged between the MFP 100 and the PC 110, and then the operator can give support to the user.

The CPU 311 determines in step S710 whether or not the CPU 311 has received the dropout request issued to the support URL from the MFP 100 and the PC 110. In the case where it is determined that the CPU 311 has received the dropout request, the processing advances to step S711. In step S711, the CPU 311 discards the support URL and ends the processing.

Processing Procedure of Management Server

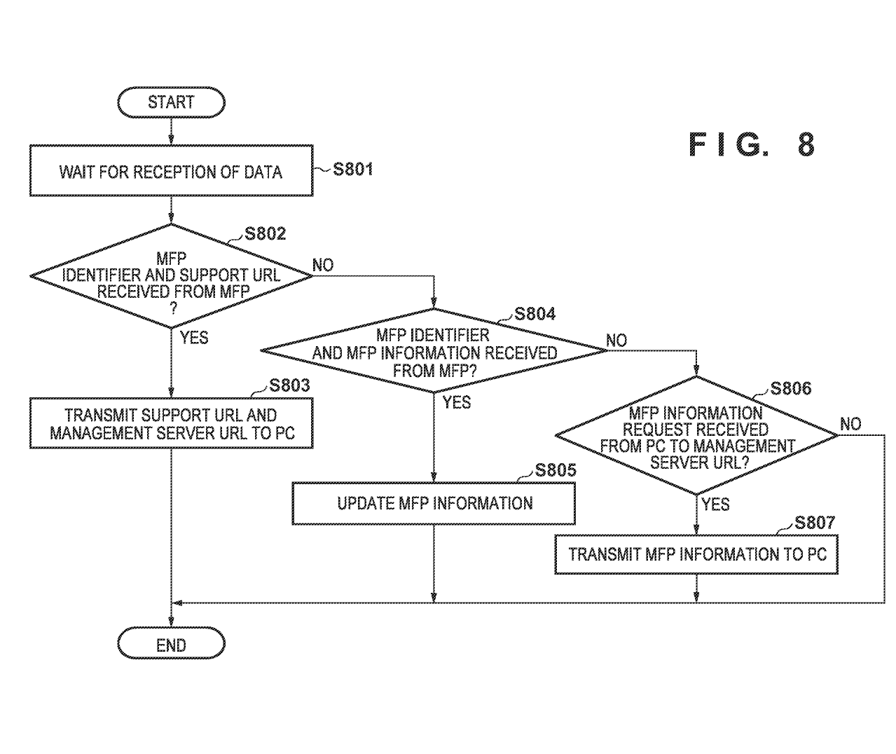

Next, the processing procedure of the management server 130 will be described with reference to FIG. 8. Operations (steps, S) shown in the flowchart of FIG. 8 are realized by the CPU 311 of the management server 130 executing a control program stored in the HDD 314.

In step S801, the CPU 311 waits for reception of data. Upon receiving some kind of data, the CPU 311 determines in step S802 whether or not the received data includes the MFP identifier and the support URL from the MFP 100. In the case where the received data includes the MFP identifier and the support URL in step S802, the processing advances to step S803, whereas in the case where the received data does not include the MFP identifier and the support URL, the processing advances to step S804.

The CPU 311 transmits the support URL and the management server URL to the PC 110 in step S803 and ends the processing. On the other hand, the CPU 311 determines in step S804 whether or not the received data includes the MFP identifier and the MFP information from the MFP 100. In the case where the received data includes the MFP identifier and the MFP information in step S804, the processing advances to step S805, whereas if the received data does not include the MFP identifier and the MFP information, the processing advances to step S806.

In step S805, the CPU 311 updates the MFP information table 131 linked with the received MFP identifier using the received MFP information and ends the processing. On the other hand, the CPU 311 determines in step S806 whether or not the received data includes the MFP information request transmitted from the PC 110 to the management server URL. In the case where the received MFP data includes the MFP information request in step S806, the processing advances to step S807, whereas in the case where the received MFP data does not include the MFP information request, the processing ends. Upon receiving the MFP information request, the CPU 311 acquires the MFP information from the MFP information table 131 and transmits the acquired MFP information to the PC 110 in step S807, and then ends the processing.

As described above, a communication system according to the present embodiment includes the image processing apparatus, the information processing apparatus that can perform remote support on the image processing apparatus, and the management server that manages information relating to the image processing apparatus. Upon accepting a remote support service start request issued from the image processing apparatus, if the information managed by the management server is not the latest information, the image processing apparatus issues a request regarding the latest information and start of the remote support service to the management server. On the other hand, if the information managed by the management server is the latest information, the image processing apparatus issues a request regarding start of the remote support service to the management server without updating the information. MFP information acquired by the PC 110 during the support that is started on the PC 110 in accordance with the support start request issued from the MFP 100 is the latest MFP information, and thus the support can be performed immediately.

Also, according the present embodiment, in the case where the latest information is not managed by the management server when the remote support service ends, the image processing apparatus may issue a notification of the information. Accordingly, although it is conceivable that the status of the image processing apparatus will change from the previous status at a stage when the remote support service ends, it is possible to handle such a change. Also, a configuration is possible in which the image processing apparatus periodically transmits information relating to the image processing apparatus to the management server, and when a remote support service is started, the image processing apparatus changes the time interval to a shorter time interval than before the remote support service is started. Accordingly, it is possible to handle a situation in which the status of the image processing apparatus changes at a relatively short time interval during the remote support service.

### Second Embodiment

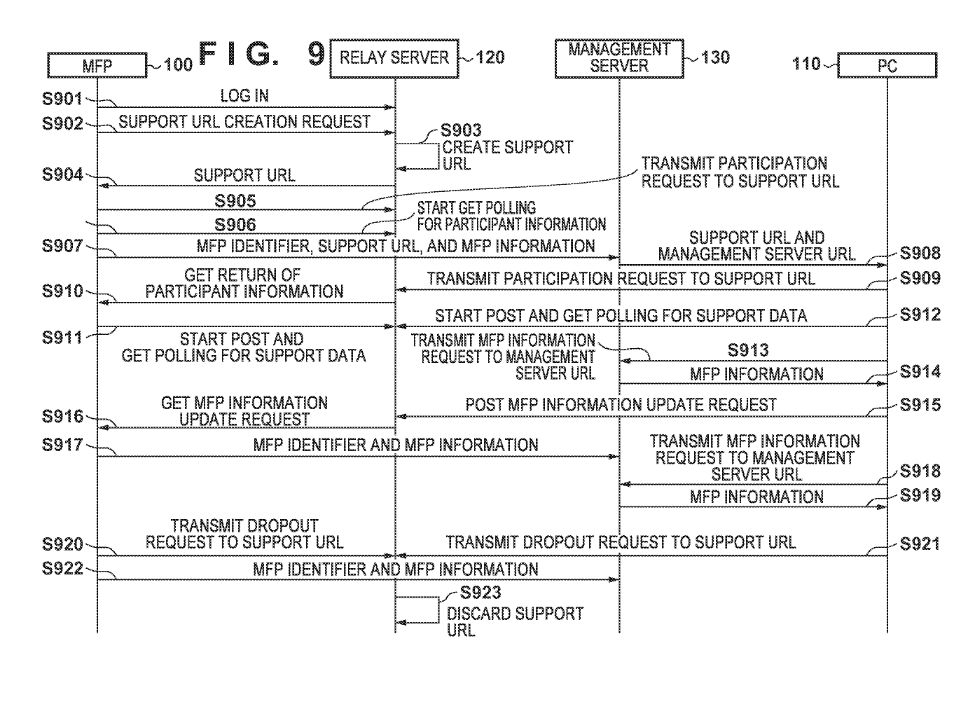

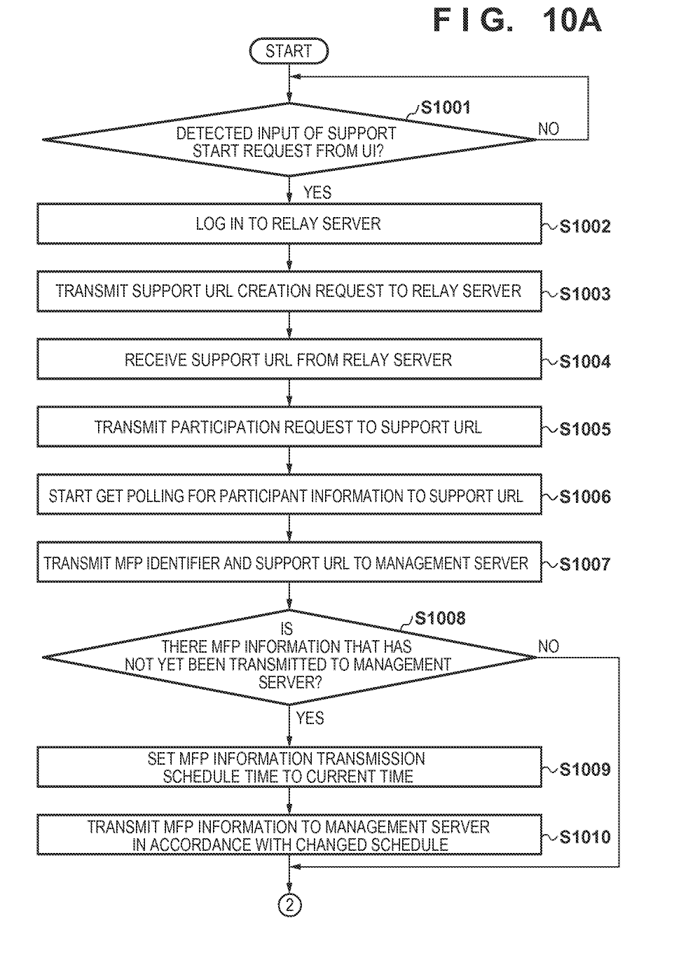

Hereinafter, a second embodiment of the present invention will be described with reference to FIGS. 9 to 11. Here, a method in which the MFP 100 transmits MFP information to the management server 130 in accordance with an instruction of the PC 110 during support will be described. Note that description of a configuration and control similar to those in the above-described first embodiment is omitted. For example, the overall configuration of the communication system shown in FIG. 1, the configurations of the MFP 100, the PC 110, the relay server 120, and the management server 130 shown in FIGS. 2 and 3 are similar to those of the above-described first embodiment, and thus detailed description thereof is omitted.

Sequence

First, sequences of the MFP 100, the PC 110, the relay server 120, and the management server 130 will be described with reference to FIG. 9. The processing described below is realized by the CPU 211 of the MFP 100 executing a control program stored in the HDD 214. Also, the processing is realized by the CPUs 311 of the PC 110, the relay server 120, and the management server 130 executing control programs stored in the HDDs 314. The processing of step S901 to step S914 is similar to that of step S401 to step S414 of FIG. 4 in the above-described first embodiment, and thus detailed description thereof is omitted.

After the support is started, if there is a possibility that the status of the MFP 100 will change due to the support of the operator, the operator request update of MFP information via the PC 110. Therefore, in step S915, the PC 110 posts the request to update the MFP information on the relay server 120. Subsequently, in step S916, the relay server 120 receives the MFP information update request from the PC 110, and notifies the MFP 100 of getting the request. In step S917, the MFP 100 transmits the MFP identifier and the MFP information to the management server 130 in accordance with the MFP information update request.

Thereafter, similarly to the processing of steps S913 and S914, the PC 110 acquires the MFP information in steps S918 and S919. The processing of step S920 to step S923 is similar to the processing of step S415 to step S418 of FIG. 4 in the above-described first embodiment, and thus detailed description is omitted.

Processing Procedure of MFP

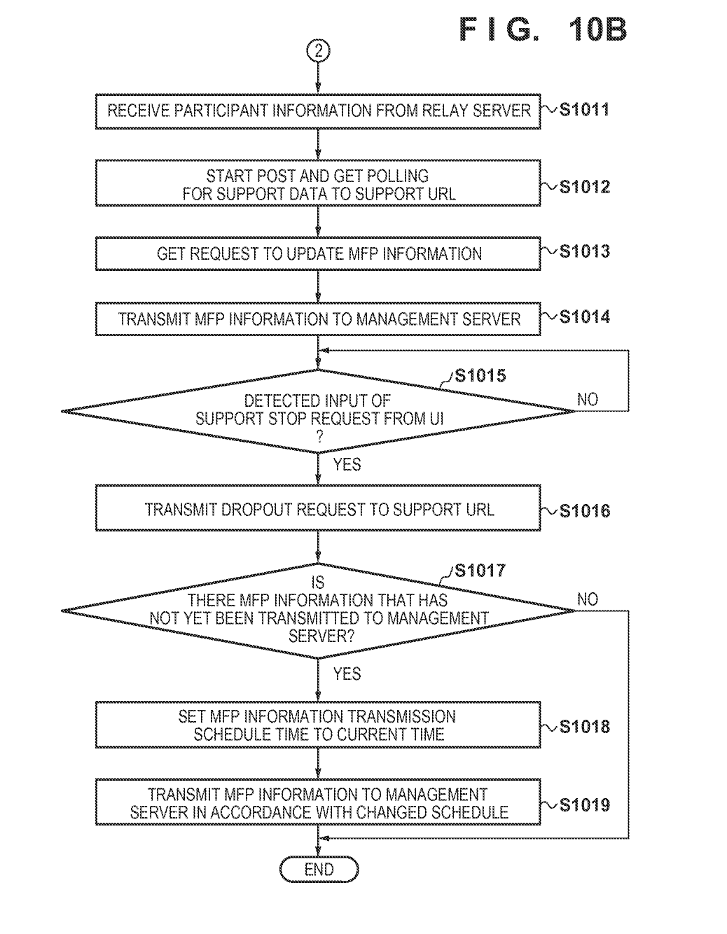

Next, the processing procedure of the MFP 100 will be described with reference to FIGS. 10A and 10B. Operations (steps, S) shown in the flowchart of FIGS. 10A and 10B are realized by the CPU 211 of the MFP 100 executing a control program stored in the HDD 214. The processing of step S1001 to step S1012 is similar to the processing of step S501 to step S512 of FIGS. 5A and 5B in the above-described first embodiment, and thus detailed description is omitted.

When the support is started, the CPU 211 determines in step S1013 whether or not getting the MFP information update request, of which the relay server 120 notifies the MFP 100, is detected. If the update request is detected, the processing advances to step S1002. In step S1014, the CPU 211 transmits the MFP identifier and the MFP information to the management server 130. The processing of step S1015 to step S1019 is similar to the processing of step S514 to step S519 except for step S516 of FIG. 5B in the above-described first embodiment, and thus detailed description is omitted.

Processing Procedure of PC

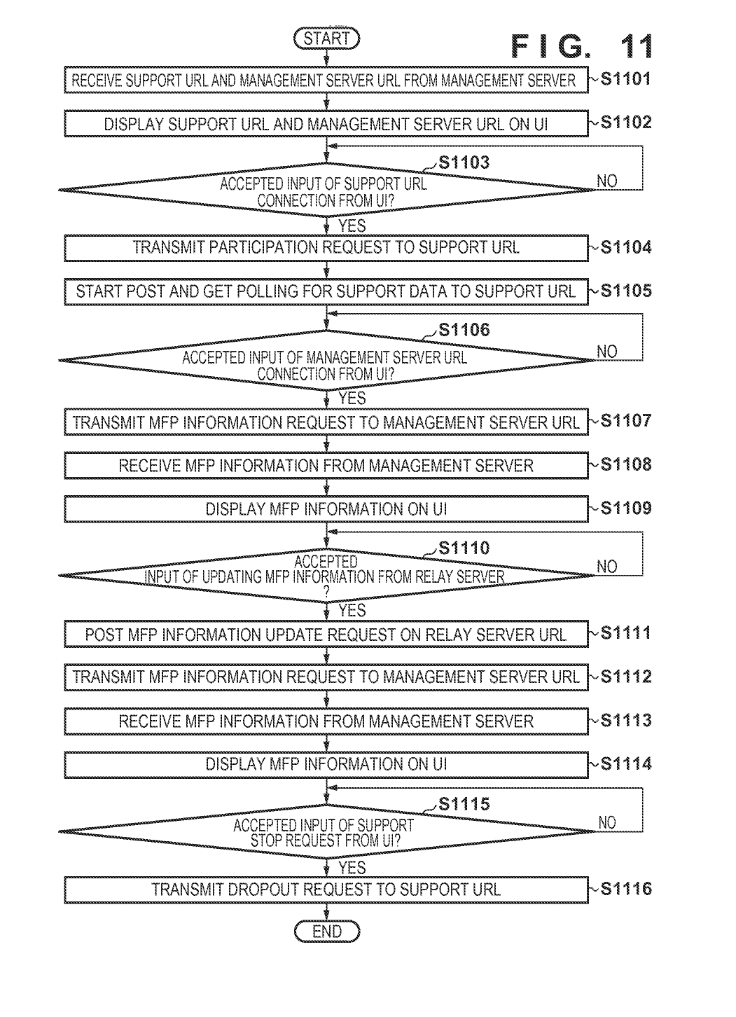

Next, the processing procedure of the PC 110 will be described with reference to FIG. 11. Operations (steps, S) shown in the flowchart of FIG. 11 are realized by the CPU 311 of the PC 110 executing a control program stored in the HDD 314. The processing of step S1101 to step S1109 is similar to the processing of step S601 to step S609 of FIG. 6 in the above-described first embodiment, and thus detailed description is omitted.

When the support is started, the CPU 311 determines in step S1110 whether or not the CPU 311 has accepted the input of an update of MFP information on a UI. If it is determined that the CPU 311 has accepted the request, in step S1111, the CPU 311 posts the MFP information update request on the relay server 120. The update request corresponds to a request, which serves as a GET target, in step S1013 of the MFP 100. The MFP 100 performs the processing of step S1014 in accordance with the update request and updates the MFP information of the management server 130.

When the processing of step S1111 ends, similarly to the processing of step S1107 to step S1109, the CPU 311 acquires the MFP information from the management server 130 in step S1112 to step S1114. The processing of steps S1115 and S1116 is similar to the processing of steps S610 and S611 of FIG. 6 in the above-described first embodiment, and thus detailed description is omitted.

As described above, according to the present embodiment, it is possible to update MFP information at any time while an operation is performed on the PC 110 during support that is started in accordance with the support start request issued from the MFP 100 and is performed on the PC 110, and it is possible to immediately handle a change in the MFP information.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-176220 filed on Aug. 29, 2014, which is hereby incorporated by reference herein in its entirety.

What is claimed is:

1. A communication system including an image processing apparatus, an information processing apparatus configured to perform remote support on the image processing apparatus, and a management server configured to manage information relating to the image processing apparatus;
the image processing apparatus comprises:
an acceptance unit configured to accept a remote support service start request issued from the information processing apparatus;
a determination unit configured to determine whether or not the information that is managed by the management server and relates to the image processing apparatus is latest information; and
a request unit configured to, in a case where the determination unit determines that the information that is managed by the management server and relates to the image processing apparatus is not the latest information, issue a request regarding the latest information and start of the remote support service to the management server, and, in a case where the determination unit determines that the information that is managed by the management server and relates to the image processing apparatus is the latest information, issue a request regarding start of the remote support service to the management server; and
an acquisition unit configured to acquire information relating to the remote support service from the information processing apparatus, and
the management server comprises:
a management unit configured to manage information of a plurality of apparatuses included in the communication system; and
a notification unit configured to, upon accepting the remote support service start request from the image processing apparatus, notify the information processing apparatus providing the remote support service of the remote support service start request, and notify the information processing apparatus of the information that is managed by the management server and relates to the image processing apparatus in accordance with the request from the information processing apparatus.

2. The communication system according to claim 1, wherein
if the information relating to the image processing apparatus is updated after the information relating to the image processing apparatus was most recently transmitted to the information processing apparatus, the determination unit determines that the information that is managed by the management server and relates to the image processing apparatus is not the latest information.

3. The communication system according to claim 1, wherein
the image processing apparatus further comprises a transmission unit configured to transmit the information relating to the image processing apparatus to the management server at a predetermined time interval.

4. The communication system according to claim 3, wherein
when the remote support service is started, the transmission unit changes the predetermined time interval to a shorter time interval than before the remote support service is started.

5. The communication system according to claim 3, wherein
the image processing apparatus performs a determination using the determination unit when the remote support service ends, and in a case where the determination unit determines that the information that is managed by the management server and relates to the image processing apparatus is not the latest information, transmits the latest information to the management server using the transmission unit.

6. The communication system according to claim 1, wherein
the information processing apparatus comprises an operation unit configured to accept a request to update the information relating to the image processing apparatus from a user, and
the image processing apparatus notifies, in a case where the operation unit has accepted the request to update the information relating to the image processing apparatus, the management server of latest information relating to the image processing apparatus in accordance with the request of which the information processing apparatus notifies the image processing apparatus.

7. The communication system according to claim 1, wherein
the information relating to the image processing apparatus includes at least one of operating information relating to a processing result of the image processing apparatus and failure information relating to failure occurrence in the image processing apparatus.

8. An image processing apparatus configured to receive remote support from an information processing apparatus, the image processing apparatus comprising:
an acceptance unit configured to accept a remote support service start request issued from the information processing apparatus;
a determination unit configured to determine whether or not information that is managed by a management server to be connected via a network and relates to the image processing apparatus is latest information;
a request unit configured to, in a case where the determination unit determines that the information that is managed by the management server and relates to the image processing apparatus is not the latest information, issue a request regarding the latest information and start of the remote support service to the management server, and, in a case where the determination unit determines that the information that is managed by the management server and relates to the image processing apparatus is the latest information, issue a request regarding start of the remote support service to the management server; and
an acquisition unit configured to acquire information relating to the remote support service from the information processing apparatus having the latest information that is notified via the management server and relates to the image processing apparatus.

9. A method for controlling an image processing apparatus configured to receive remote support from an information processing apparatus, the method comprising:
accepting a remote support service start request issued from the information processing apparatus;
determining whether or not information that is managed by a management server to be connected via a network and relates to the image processing apparatus is latest information;
issuing a request regarding the latest information and start of the remote support service to the management server in a case where it is determined in the determining that the information that is managed by the management server and relates to the image processing apparatus is not the latest information, and, issuing a request regarding start of the remote support service to the management server in a case where it is determined in the determining that the information that is managed by the management server and relates to the image processing apparatus is the latest information; and
acquiring information relating to the remote support service from the information processing apparatus having the latest information that is notified via the management server and relates to the image processing apparatus.

10. A non-transitory computer-readable storage medium storing a computer program for causing a computer to execute each step in a method for controlling an image processing apparatus, the method comprising:
accepting a remote support service start request issued from the information processing apparatus;
determining, by a determination unit, whether or not information that is managed by a management server to be connected via a network and relates to the image processing apparatus is latest information;
issuing a request regarding the latest information and start of the remote support service to the management server in a case where it is determined in the determining that the information that is managed by the management server and relates to the image processing apparatus is not the latest information, and, issuing a request regarding start of the remote support service to the management server in a case where it is determined in the determining that the information that is managed by the management server and relates to the image processing apparatus is the latest information; and
acquiring information relating to the remote support service from the information processing apparatus having the latest information that is notified via the management server and relates to the image processing apparatus.
